(19) United States
(12) Patent Application Publication
(10) Pub. No.: US 2004/0069770 A1
(43) Pub. Date: Apr. 15, 2004

(54) Glass/metal laminate for appliances

(75) Inventors: Karen Cary, Louisville, KY (US); Theodore A. Wegert, Louisville, KY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Corporation, Yonkers, NY

(21) Appl. No.: 10/663,156

(22) Filed: Sep. 15, 2003

Related U.S. Application Data
(60) Provisional application No. 60/417,900, filed on Oct. 11, 2002.

(51) Int. Cl. H05B 3/06

(52) U.S. Cl. 219/522

(57) ABSTRACT

A glass/metal laminate for an appliance or the like and a method of fabricating the same. The glass/metal laminate includes a glass sheet, a metal sheet, and an adhesive layer bonding the glass and metal sheets together, whereby the metal sheet is visible through the glass sheet. The laminate is preferably installed on the outer surface of a refrigerator, oven, or other appliance to provide a durable and visually appealing finish surface. The laminate may be fabricated in a batch process, using a sealed curing chamber under reduced pressure to remove entrained air bubbles from the adhesive layer. Alternatively, the laminate may be fabricated in a continuous process using a pair of counter-rotating rollers to remove air from the adhesive layer. A UV light source emits radiation which passes through the glass sheet to cure the adhesive layer.

### CROSS REFERENCE TO RELATED APPLICATION

This application claims the benefit of U.S. Provisional Patent Application No. 60/417,900, filed Oct. 11, 2002, which is incorporated by reference herein as if fully set forth.

### BACKGROUND

The present invention relates generally to materials used for appliances, specifically stainless steel shelled kitchen appliances. More specifically, the invention relates to a stainless steel/glass laminate for use as a decorative covering for an appliance, such as a refrigerator, freezer, oven, microwave, range hood, or dishwasher, or other items, for example, a fireplace enclosure.

An emerging trend in the home appliance market is the use of stainless steel as the outer shell of the appliance. Many consumers find the industrial-like look of stainless steel visually appealing, and assume that the quality of stainless steel clad appliances is higher than that of appliances with other types of shell covers. While stainless steel is an appropriate cladding for industrial-type appliances, due to the reality that stainless steel is costly, heavy, and difficult to clean, significant drawbacks occur in its use in the non-industrial market. Specially formulated cleaners need to be used to remove fingerprints, dust, splatter and other dirt that commonly accumulates in the home environment. Commonly used abrasives will also leave visible scratches on the surface of the stainless steel, altering the uniform appearance.

It would be desirable to provide a material with the industrial appearance of stainless steel, for such applications, that is both lighter and easier to maintain in a non-industrial environment. It would also be desirable to accomplish this objective while maintaining the durability associated with stainless steel appliance enclosures.

### SUMMARY

The present invention provides a novel glass/metal laminate for use as a shell on an appliance or other article and a method of fabricating the novel glass/metal laminate. The glass/metal laminate includes a glass sheet, a metal sheet, and an adhesive layer bonding the glass and metal sheets, whereby the metal sheet is visible through the glass sheet. The finished laminate is preferably installed on the outer surface of a refrigerator, oven, or other appliance or article to provide a durable and visually appealing finish, which can appear similar to stainless steel or other types of finishes.

In one aspect of the invention, the laminate is fabricated using a batch process performed in a sealed curing chamber. Air pressure is reduced in the curing chamber to allow entrained air bubbles in the adhesive layer to dissipate to produce a more visually appealing finished product. After the air bubbles have dissipated, the fabricated laminate is exposed to UV radiation through the glass sheet to cure the adhesive layer.

In another aspect of the invention, the laminate is fabricated using a continuous process. A glass or metal sheet is fed along a conveyor or similar apparatus and the adhesive layer is applied with a roller. A mating glass or metal sheet is placed on top of the adhesive layer. The glass/metal laminate is compressed between two counter rotating rollers which remove entrained air bubbles from the adhesive layer. In the last step of the process, a UV light source cures the adhesive layer by passing UV radiation through the glass sheet.

### BRIEF DESCRIPTION OF THE DRAWINGS

This invention will be described in further detail below with reference to the attached drawings. In the drawings:

FIG. 1 is a perspective view of one embodiment of a glass/metal laminate according to the present invention.

FIG. 2 is a schematic diagram of a first system for the manufacturing of a glass/metal laminate according to the present invention.

FIG. 3 is a schematic diagram of a second system for the manufacturing of a glass/metal laminate according to the present invention.

FIG. 4 is a schematic diagram of a third system for the manufacturing of a glass/metal laminate according to the present invention.

FIG. 5 is a schematic diagram of a fourth system for the manufacturing of a glass/metal laminate according to the present invention.

### DETAILED DESCRIPTION OF THE PREFERRED EMBODIMENTS

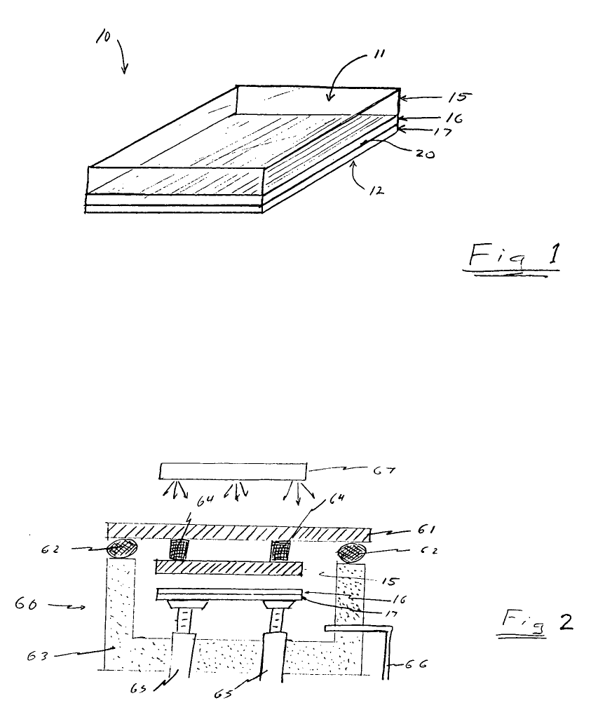

The present invention provides thin sheets of metal bonded to glass panels as an alternative to using stainless steel for home and commercial appliances. FIG. 1 shows a first embodiment of a glass/metal laminate 10 according to the present invention. The glass/metal laminate 10 is comprised of at least one layer of glass sheet 15, an adhesive layer 16, and a metal sheet 17.

The glass sheet 15 may be composed of any glass which would be suitable for an appliance surface. Such glass may include, but is not limited to PYREX, quartz, borosilicate, soda lime, annealed glass, alkali-free borosilicate glass, or any other suitable glass. The top 11 of the glass sheet 15 may have a shiny surface or it may be a matte surface.

The metal sheet 17 may be a thin sheet or foil of any metal or other suitable material that has the aesthetic properties of stainless steel or any other desired decorative layer. These sheets may be made out of aluminum, steel, chromium, cobalt, nickel, zinc, silver, platinum, or any other suitable material. The surface 20 of the metal sheet 17 may be finished in such a way to give aesthetically equivalent characteristics as that of a stainless steel panel.

The adhesive layer 16 is comprised of any adhesive product that is transparent and which would allow the consumer to see through the panel to the metal sheet behind it. Such adhesives may include, but are not limited to, acrylic adhesives, adhesive films, anaerobic adhesives, epoxies, heat activated adhesives, hot melt adhesives, hydrocolloids/hydrogel adhesives, moisture cured adhesives, polyester adhesives, pressure sensitive adhesives, silicone adhesives, urethane adhesives, light cured adhesives, and UV cured adhesives. The most preferable adhesive of the present invention is a radiation-cured adhesive. Radiation-cured adhesives such as light cured adhesives and UV curable adhesives are found essentially of low or medium molecular weight resins, monofunctional or multifunctional monomers, additives, pigments, photoinitiators and/or photosynthesizers. Any suitable type of UV curing can be used in the present invention that is compatible with the metal and glass being bonded.

The metal/glass laminate 10 is preferably affixed to a surface of an appliance, such as a refrigerator, a freezer, a dishwasher, a microwave oven, a conventional oven, a stovetop range, an exhaust hood, or any other appliance or article.

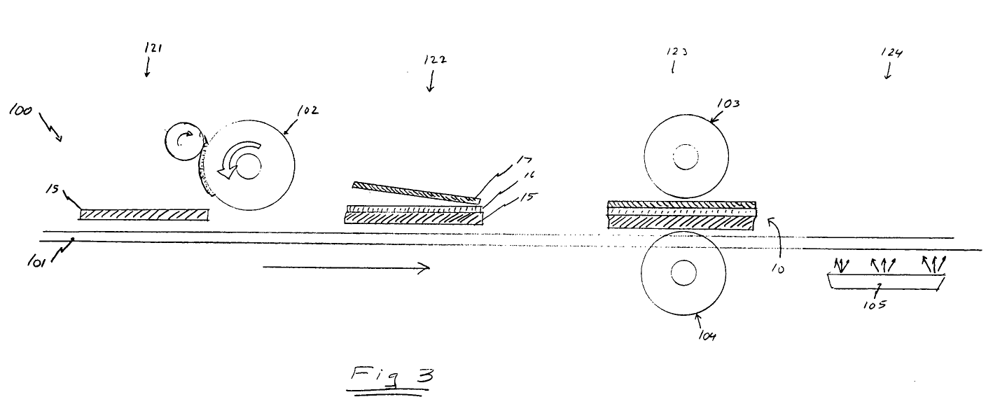

The manufacturing of the glass/metal laminate 10 must be carried out so that there are no air bubbles in the adhesive layer 16. This would detract from the aesthetic appearance of the laminate 10. The preferred process comprises either a batch process, or a continuous process. One embodiment of the batch process according to the present invention is performed in a curing chamber. In accordance with the present invention as shown in FIG. 2, a glass sheet 15 is suspended in a sealed curing chamber 60, having a body 63 and a cover 61, by suspension devices 64. The suspension devices 64 may be attached to the body 63 of the sealed curing chamber 60 or may be attached to the curing chamber cover 61. Vacuum-grade gaskets 62 are located between the curing chamber cover 61 and the body 63. At least one external actuator 65 extends into the chamber 60 and holds the metal sheet 17. A UV light source 67 is located over the sealed curing chamber 60 in order to cure the adhesive. The metal sheet 17, which is coated with an adhesive 16, is raised using external actuator 65 and pressed uniformly against the glass sheet 15. The atmospheric pressure within the chamber is reduced by a vacuum pump connected to the vacuum line 66. The atmosphere within the sealed curing chamber may be air, and more preferably is a moisture-free air or pure nitrogen. The reduced pressure within the sealed curing chamber during this process is 500 mbars or less, more preferably 300 mbars or less, and most preferably 150 mbars or less. Any trapped air or gas within the high viscosity adhesive layer is thus removed by the use of this vacuum. The sealed curing chamber cover 61 is made of a clear, UV transmitting material, which allows an operator to see that the adhesive layer is even and smooth, and that all air bubbles have been eliminated. Following this, radiation from a UV light source 67 is then applied, and curing occurs by reaction initiated by UV radiation that is transmitted through the sealed curing chamber cover while the system is at reduced pressure. The complete glass-metal laminate is then removed from the sealed curing chamber.

This process is applicable to join any decorative layers such as colored metal sheets, plastic or other metallic or nonmetallic layers to glass or similar clear substrates. The glass sheet and the metal sheet may be in a flat or a curved shape, and more preferably is flat. Any clear adhesive which is curable by radiation, heat, moisture or other suitable means may be used for this invention. More preferably, the adhesive is clear and colorless. The completed panel that is produced by this procedure can be attached to any flat surface or support on residential or commercial appliances such as refrigerator doors, freezer doors, cooktops, control panels, backsplashes, shelves, stoves, microwave ovens, ovens, fume hoods, etc.

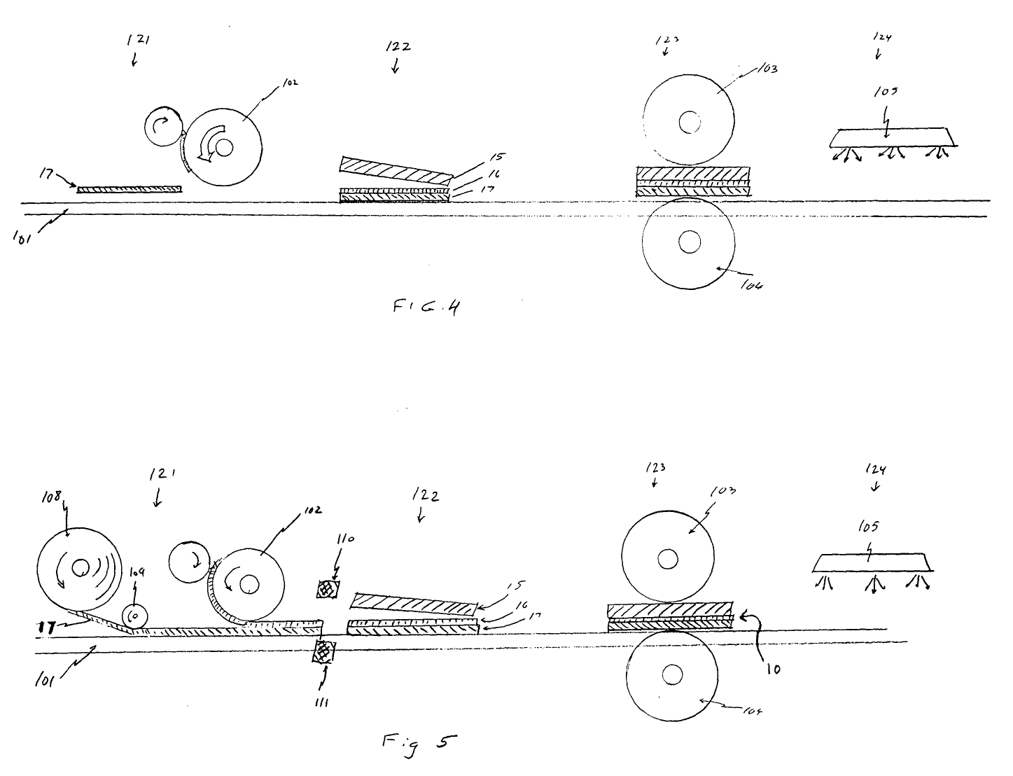

Another process for forming the laminate in accordance with this invention will be explained with reference to FIG. 3. A pressurized roller system 100 comprises a conveyer belt 101 onto which glass sheet 15 is deposited. In the adhesive dispensing stage 121, the glass sheet is conveyed to a roller coater 102 that automatically dispenses a thin coat of UV curable adhesive 16. The glass sheet 15 with the adhesive layer 16 is then conveyed to a bonding stage 122 where a metal sheet 17 is placed on the adhesive layer 16. This glass metal laminate proceeds through a press stage 123 where pressure is applied to the metal/glass laminate 10 by a bottom roller 104 and a top roller 103. The outer surface of the bottom roller 104 and top roller 103 can be made out of any material suitable for this purpose. Within the press stage 123, essentially all of the entrained air bubbles within the adhesive 16, as well as any off-gassing from the adhesive 16, is squeezed out from between the metal and glass layers at this point in the manufacturing process. The glass/metal laminate is then irradiated by a UV light source 105 as it exits the roller in curing stage 124. In the curing stage 124, the UV light source 105 is mounted in such a way that the UV curable adhesive is exposed to the UV radiation. This can be done by mounting the UV light source 105 underneath a UV-transparent conveyor belt, or by having sufficient gaps in the conveying apparatus. Additional rollers 103, 104 may also be provided in this stage to maintain pressure on the laminate as the adhesive is cured. Alternatively, the laminate may be manufactured with the glass sheet 15 on top as the UV light source 105 would then be mounted over the conveyor as shown in FIG. 4.

Alternatively, as shown in FIG. 5, a continuous metal sheet may be unwound from spool 108 through a roller 109 onto the conveyor apparatus 101. In the adhesive dispensing stage 121, the metal sheet 17 proceeds to the dispensing roller coater 102 which automatically dispenses a thin coat of adhesive 16. After the adhesive dispensing stage 121, the metal strip coated with adhesive goes through a cutting apparatus 110, 111 where the coated metal strip is attached to the length of the glass metal laminate. In the press stage 122, a glass sheet 15 is lowered onto the adhesive 16 from where the glass/metal laminate 10 proceeds into the squeezing stage 123. In this stage, pressure is applied by rollers 103 and 104 to squeeze out air bubbles trapped in the UV curable adhesive layer 16, as well as any off-gassing that occurs in the adhesive 16. The glass/metal laminate 10 is then immediately irradiated by the UV light source 105 as it exits the rollers into the curing stage 124.

While the preferred embodiment of the invention has been described in detail, the invention is not limited to the specific embodiment described above, which should be considered as merely exemplary. Further modifications and extensions of the present invention may be developed, and all such modifications are deemed to be within the scope of the present invention.

What is claimed is:

1. An appliance, having a panel formed from a glass/metal laminate comprising:
a metal sheet;
a substantially air-bubble free, thin and even adhesive layer on a surface of the metal sheet; and
a glass sheet attached to the adhesive layer so that an entire space between the glass sheet and the metal sheet is filled with the adhesive layer.

2. The appliance of claim 1, wherein the glass sheet of the panel is exposed on an outer surface of the appliance.

3. The appliance of claim 1, wherein the metal sheet is stainless steel.

4. The appliance of claim 1, wherein the adhesive is radiation curable.

5. The appliance of claim 1, wherein the glass is borosilicate glass.

6. The appliance of claim 1, wherein the metal sheet includes a surface finish.

7. The appliance of claim 1, wherein the adhesive is transparent.

8. A method for producing a laminate, the method comprising:
providing a metal sheet;
providing a glass sheet;
applying an adhesive layer on a surface of at least one of the glass and metal sheets;
placing the glass sheet and metal sheets in a sealed curing chamber adjacent each other;
reducing air pressure in the sealed curing chamber;
permitting entrained air bubbles in the adhesive layer to dissipate; and
connecting the glass and metal sheets with the adhesive layer sandwiched therebetween

9. The method of claim 8, wherein the step of connecting the sheets includes the step of uniformly pressing the sheets together.

10. The method of claim 8, further comprising the step of curing the adhesive layer.

11. The method of claim 10, wherein the step of curing the adhesive layer includes the step of applying UV radiation to the adhesive layer though the glass sheet.

12. The method of claim 10, wherein the step of applying UV radiation includes the step of applying UV radiation through a UV transparent window in the sealed curing chamber.

13. The method of claim 8, wherein the step of reducing the air pressure is performed prior to the step of connecting the glass and metal sheets.

14. The method of claim 8, wherein the step of permitting the entrained air bubbles to dissipate occurs prior to, during, and subsequent to the step of connecting the glass and metal sheets.

15. The method of claim 8, wherein the step of reducing the pressure includes the step of reducing the pressure to 150 mbars or less.

16. The method of claim 8, further comprising the step of providing a substantially moisture free air atmosphere in the sealed curing chamber.

17. The method of claim 8, further comprising the step of providing a substantially nitrogen atmosphere in the sealed curing chamber.

18. A method for producing a laminate, comprising:
applying an adhesive layer to a surface of one of a metal sheet and a glass sheet using a roller coater;
placing the other of the glass sheet and the metal sheet on the adhesive layer whereby the adhesive layer resides between the metal and glass sheets;
applying pressure to the metal and glass sheets by at least one roller to remove entrained air bubbles in the adhesive layer; and
curing the adhesive layer.

19. The method according to claim 18, wherein the step of curing the adhesive layer includes the step of applying UV radiation to the adhesive layer though the glass sheet.

20. The method according to claim 18, wherein the step of curing the adhesive layer occurs substantially immediately after the step of applying pressure to the metal and glass sheets.

21. The method according to claim 18, wherein the step of applying an adhesive layer includes applying the adhesive to a surface of a substantially continuous metal sheet using a roller coater.

22. The method according to claim 21, further comprising the step of cutting the continuous metal sheet at discrete intervals.

23. The method according to claim 22, wherein the step of cutting the continuous metal sheet is performed prior to the step of placing the glass.

24. The method according to claim 18, wherein the step of applying pressure to the metal and glass sheets includes the step of applying pressure to the metal and glass sheets using two rollers which receive the metal and glass sheets therebetween.

25. The method according to claim 18, wherein the step of applying an adhesive layer includes the step of applying a substantially thin and even transparent adhesive layer over an entire surface of the metal sheet.
